(19) United States
(12) Patent Application Publication
(10) Pub. No.: US 2011/0273512 A1
(43) Pub. Date: Nov. 10, 2011

(54) DEVICE FOR ROTATING LIQUID JETTING HEAD, LIQUID JETTING RECORDING DEVICE, AND METHOD FOR FILLING LIQUID JETTING RECORDING DEVICE WITH LIQUID

(76) Inventors: Tetsuya Murase, Chiba (JP); Akihiro Sadaki, Chiba (JP)

(21) Appl. No.: 12/998,952

(22) PCT Filed: Dec. 9, 2009
(86) PCT No.: PCT/JP2009/070586

§ 371 Date: Jul. 18, 2011

(30) Foreign Application Priority Data
Dec. 17, 2008 (JP) 2008-320798

(51) Int. Cl. B41J 23/00

(52) U.S. Cl. 347/38

(57) ABSTRACT

Provided are a rotating device for a liquid jet head, a liquid jet recording apparatus, and a method of filling liquid into a liquid jet recording apparatus, which are capable of keeping print precision, simplifying the structure, and reducing manufacturing cost. A rotating device (60) includes a rotating unit (62) to which an ink jet head (10) is attached, and a base unit (61) for rotatably supporting the rotating unit. The rotating unit includes a rotating plate (63) rotatably supported by the base unit via a rotating shaft (69), and a slide mechanism (65) supported so as to be slidable in a direction of a radius of the rotation shaft (69) with respect to the rotating plate and to which the ink jet head is attached. The slide mechanism is formed so as to slide with respect to the rotating plate in synchronization with rotating operation of the rotating plate.

### TECHNICAL FIELD

The present invention relates to a rotating device of a liquid jet head for jetting liquid from nozzles to record an image or text on a recording medium, a liquid jet recording apparatus, and a method of filling liquid into a liquid jet recording apparatus.

### BACKGROUND ART

Generally, a liquid jet recording apparatus, for example, an ink jet printer which carries out various kinds of printing, includes transfer means for transferring a recording medium and an ink jet head (liquid jet head). As an ink jet head used here, there is known an ink jet head including a nozzle body (jetting body) having a nozzle column (jetting hole column) formed of a plurality of nozzle holes (jetting holes), a plurality of pressure generating chambers which are paired with and communicate with the nozzle holes, respectively, an ink supply system for supplying ink to the pressure generating chambers, and a piezoelectric actuator disposed adjacent to the pressure generating chambers, in which the piezoelectric actuator is driven to pressurize the pressure generating chambers to cause ink in the pressure generating chambers to be jetted from orifices (nozzles) in the nozzle holes.

As a kind of such an ink jet printer, there is an ink jet printer in which ink is discharged under a state in which the direction of openings of orifices of the ink jet head is the direction of gravity to carry out printing on an upper surface of a recording medium which is transferred below the ink jet head (see, for example, Patent Document 1).

In an ink jet printer of such a kind, in order to improve print precision, it is necessary to set as small as possible a clearance between a nozzle surface of the ink jet head and a recording medium.

By the way, in the above-mentioned ink jet printer, there is a structure in which, in order to perform maintenance such as filling of ink and cleaning of nozzle holes, the ink jet head is capped with a suction cap and sucked under negative pressure to initially fill the nozzle holes with ink, and dust around the nozzle holes is removed.

However, because, as described above, the clearance between the nozzle surface of the ink jet head and a recording medium is set to be small, it is necessary to bring the ink jet head closer to the recording medium accordingly. Then, because the recording medium is moved by transfer means such as a belt conveyor, with regard to an ink jet head in which there is a distance between a lowest portion of the ink jet head and the lowest nozzle hole in a nozzle column like a conventional ink jet head, it is difficult to carry out printing on a lower portion of a recording medium or printing on a recording medium the vertical dimension of which is small.

Accordingly, as disclosed in Patent Document 1, for example, a structure is known in which a service station for maintenance is provided in a movable range of the ink jet head and the ink jet head is moved to the service station at which maintenance is performed.

### Patent Document 1: JP 07-205438 A

### DISCLOSURE OF THE INVENTION

### Problems to be Solved by the Invention

However, in the structure disclosed in Patent Document 1 described above, in order to perform maintenance on the ink jet head, it is necessary to move the ink jet head to a service station. Because it is necessary to additionally provide a service station and a structure for guiding the ink jet head to the service station, there are problems that the structure is complicated and the manufacturing cost increases.

Accordingly, the present invention has been made in view of the above, and provides a rotating device for a liquid jet head, a liquid jet recording apparatus, and a method of filling liquid into a liquid jet recording apparatus, which are capable of keeping print precision, and still, capable of simplifying the structure and reducing manufacturing cost.

### Means for Solving the Problems

In order to solve the problems described above, the present invention adopts the following means.

As solving means related to a rotating device for a liquid jet head, there is provided a rotating device for a liquid jet head to which a liquid jet head for discharging liquid toward a recording medium is attached, the rotating device being for rotating the liquid jet head between a first position at which the liquid jet head is disposed under a state in which a direction of openings of nozzles thereof is a direction of gravity and a second position at which the liquid jet head is disposed under a state in which the direction of openings of the nozzles thereof is horizontal, the rotating device including: a rotating unit to which the liquid jet head is attached; and a base unit for rotatably supporting the rotating unit, the rotating unit including: a rotating member rotatably supported by the base unit via a rotating shaft; and a slide member supported so as to be slidable in a direction of a radius of the rotation shaft with respect to the rotating member and to which the liquid jet head is attached, the slide member being formed so as to slide with respect to the rotating member in synchronization with rotating operation of the rotating member, in which the rotating shaft is disposed at an end portion in a first direction and in a second direction of the rotating unit at the second position, provided that the direction of openings of the nozzles of the liquid jet head at the first position is the first direction and the direction of openings of the nozzles of the liquid jet head at the second position is the second direction.

According to the structure, because the liquid jet head slides when the liquid jet head rotates, if the liquid jet head rotates to the first position, the liquid jet head may be disposed so as to be opposed to an upper surface of a recording medium, and if the liquid jet head rotates to the second position, the liquid jet head may be retracted from over a recording medium. Because maintenance of the liquid jet head may be performed at this second position, compared with a structure in which a liquid jet head is moved to a service station or the like as in a conventional case, the manufacturing cost of the apparatus may be reduced. In addition, because the rotating shaft is disposed at the end portion in the first direction and in the second direction, the liquid jet head in rotation does not extend downward beyond the rotating shaft too much. Therefore, at the first position, the clearance to the recording medium may be set as small as possible to improve the print precision, while, at the second position, space below the liquid jet head may be effectively used.

Further, the rotating unit includes a rack member coupled to the slide member, and the base unit includes drive means for rotating the rotating shaft of the rotating member and a fixed gear fixed to the base unit under a state of being directly or indirectly engaged with the rack member.

According to the structure, when the rotating unit is rotated by driving force applied by the drive means, the rack member directly or indirectly engaged with the fixed gear slides. This may cause the slide member to slide in synchronization with the rotating operation of the rotating unit with a simple structure. Therefore, differently from a case in which the rotating operation is carried out only about a rotating shaft, protruding downward beyond the base unit too much of the rotating unit when the rotating unit rotates may be suppressed.

Further, a rocking gear which is rotatably supported by the rotating member is provided between the fixed gear and the rack member under a state of being engaged with the fixed gear and the rack member.

According to the structure, by disposing the rocking gear between the fixed gear and the rack member, the rack member may be disposed at an arbitrary position. This may improve flexibility in the design, and still, may prevent the fixed gear from becoming larger and may miniaturize the apparatus. In this case, for example, the rack member may be disposed above the rotating shaft at the first position, and space below the rotating shaft may be effectively used.

Further, the base unit includes a restricting portion for restricting a range of rotation of the rotating unit, and the rotating shaft is provided with a torque limiter for, when torque acting on the rotating shaft is equal to or higher than a predetermined value, releasing transmission of driving force from the drive means to the rotating shaft.

According to the structure, by bringing the rotating unit into contact with the restricting portion to increase torque acting on the rotating shaft, coupling between the drive means and the rotating shaft may be released so that driving force applied by the drive means is not transmitted to the rotating shaft. Because, in this way, rotation of the rotating unit stops at the time of being brought into contact with the restricting portion, compared with a case in which drive means such as a pulse motor is used, rotation error may be suppressed. This may prevent the drive means from being overloaded and may reliably rotate the rotating unit to the first position to improve the print precision.

Further, the base unit includes a plunger which is fittable in the rotating member when the liquid jet head is at the first position or at the second position.

According to the structure, when the liquid jet head is at the first position or at the second position, by the fit between the base unit and the rotating member by means of the plunger, the liquid jet head may be reliably positioned at the first position or at the second position. As a result, the direction of discharge of liquid may be kept fixed to improve the print precision.

Further, in the liquid jet, the liquid jet head includes a jetting hole column formed of a plurality of jetting holes having the nozzles and a jetting body guard formed so as to cover the jetting hole column, the jetting body guard includes a top plate portion disposed away from a surface of the jetting body and having a slit formed therein so as to be opposed to the jetting hole column and an airtight portion for hermetically sealing space between a peripheral portion of the top plate portion and the jetting body, the liquid jet head includes a suction flow path above or below the jetting hole column when the liquid jet head is disposed at the second position, the suction flow path has, on one end side thereof, a suction port which is open to inside space of the jetting body guard while another end side thereof is connected to a sucking portion, and the inside space of the jetting body guard is caused to be a negative pressure chamber by suction with the sucking portion via the suction flow path, thereby enabling suction of the liquid which overflows from the plurality of jetting holes into the negative pressure chamber.

According to the structure, excess liquid in initial filling of liquid and in normal use flows out to the negative pressure chamber which communicates with the outside only via the slit, and gas outside the negative pressure chamber flows in the negative pressure chamber via the slit. This causes excess liquid to move through the negative pressure chamber under a state in which the excess liquid is less liable to leak to the outside via the slit, and to be sucked from the suction port into the suction flow path to be discharged to the outside, and thus, liquid which flows out of the nozzles may be reliably collected and excess liquid may be prevented from leaking from the liquid jet head.

In this case, in filling liquid, only by rotating the liquid jet head to the second position, contamination of the vicinity of the liquid jet head (for example, recording medium or transfer means) due to leakage of excess liquid may be prevented, and still, liquid may be more reliably filled into the jetting holes.

Because it is not necessary to provide a cap and an ink absorber as in a conventional case, the ability to collect excess liquid may be improved with a simple structure, and space may be saved. More specifically, because the space factor in front of the nozzles of the liquid jet head may be improved, the clearance between the liquid jet head and the recording medium may be reduced. Further, because the space factor below the liquid jet head may also be improved, printing may be carried out on a lower end portion of a recording medium or on a recording medium the vertical dimension of which is small. As a result, the print precision of the liquid jet head may be improved.

Further, because liquid may be continuously discharged through the suction flow path, the ability to collect excess liquid is extremely strong and, even if a large amount of excess liquid flows out, contamination with the excess liquid may be prevented and jetting of the liquid after the liquid is filled may be stabilized. Further, initial filling of the liquid jet recording apparatus may be achieved with a simple structure.

Further, as solving means related to a liquid jet recording apparatus according to the present invention, a liquid jet recording apparatus includes: a liquid jet head for discharging liquid toward a recording medium; the rotating device according to the present invention, to which the liquid jet head is attached; and transfer means for transferring the recording medium along a predetermined direction, in which the liquid jet head is arranged above the transfer means so that the nozzles are opposed to an upper surface of the recording medium under a state of being rotated to the first position by the rotating device.

According to the structure, because the rotating device according to the present invention is attached to the liquid jet head, by arranging above the transfer means the liquid jet head under a state of being rotated to the first position, liquid is jetted from the nozzles of the liquid jet head in the first direction. This may be used as a liquid jet head of a downward jet type which carries out printing on an upper surface of a recording medium. In maintenance, by rotating the rotating unit to the second position, maintenance of the liquid jet head may be performed. More specifically, switching between printing (first position) and maintenance (second position) may be performed easily.

In this case, even if a recording medium is disposed immediately below the liquid jet head, the liquid jet head does not interfere with the recording medium when rotated. Therefore, in printing, the clearance to the recording medium may be set as small as possible to improve the print precision.

Further, a liquid jet recording apparatus includes: a liquid jet head for discharging liquid toward a recording medium; the rotating device according to the present invention, to which the liquid jet head is attached; and transfer means for transferring the recording medium along a predetermined direction, in which the liquid jet head is arranged to a side of the transfer means so that the nozzles are opposed to a side surface of the recording medium under a state of being rotated to the second position by the rotating device.

According to the structure, by arranging the liquid jet head to a side of the transfer means under a state of being rotated to the second position, liquid is jetted from the nozzles of the liquid jet head in the second direction. This may be used as a liquid jet head of a horizontal jet type which carries out printing on the side surface of the recording medium.

In this case, because it is not necessary to provide space below the liquid jet head, the liquid jet head may be disposed as low as possible, which enables printing on a lower end portion of a recording medium and printing on recording medium the vertical dimension of which is small.

Further, the liquid jet head arranged above the transfer means is disposed so as to be retracted from over the recording medium under a state of being rotated to the second position.

According to the structure, by disposing the liquid jet head arranged above the transfer means so as to be retracted from over the recording medium when the liquid jet head is rotated to the second position, in the event of leakage of excess liquid from the liquid jet head in filling liquid, contamination with the liquid which adheres to a recording medium does not occur.

Further, the liquid jet head is attached to the rotating unit so that the rotating shaft of the rotating unit is positioned at an end portion in the first direction and in the second direction of the liquid jet head at the second position.

According to the structure, because the rotating shaft is disposed at an end portion in the first direction and in the second direction, the liquid jet head in rotation does not extend downward beyond the rotating shaft too much. Therefore, at the first position, the clearance to the recording medium may be set as small as possible to improve the print precision, while, at the second position, space below the liquid jet head may be effectively used. It is to be noted that the above-mentioned end portion may be from a center portion to an extremity in the first direction and in the second direction.

Further, by movement of the liquid jet head in the direction of the radius of the rotation shaft in accordance with rotation from the first position to the second position, an end surface on an opening direction side of the liquid jet head at the first position and an end surface on a lower portion side of the liquid jet head in the direction of gravity at the second position are disposed so as to be flush with each other in the direction of gravity.

According to the structure, by disposing the end surface on a lower portion of the liquid jet head in the direction of gravity at the second position so as to be flush with the end surface on the opening direction side of the liquid jet head at the first position, the liquid jet head does not protrude downward in the direction of gravity from an outer shape of the base unit both at the first position and at the second position. Therefore, printing is possible on a location in proximity to a lower end of a recording medium which is disposed on the transfer means such as a belt conveyor.

Further, as solving means related to a method of filling liquid into a liquid jet recording apparatus according to the present invention, a method of filling liquid into a liquid jet recording apparatus according to the present invention includes performing a liquid filling step of filling the liquid under a state in which the liquid jet head is rotated to the second position by the rotating device.

According to the structure, by rotating the liquid jet head to the second position when liquid is filled thereinto, excess liquid may be prevented from leaking from the nozzles.

### EFFECT OF THE INVENTION

According to the present invention, because the liquid jet head slides when the liquid jet head rotates, if the liquid jet head rotates to the first position, the liquid jet head may be disposed so as to be opposed to the upper surface of the recording medium, and if the liquid jet head rotates to the second position, the liquid jet head may be retracted from over the recording medium. Because maintenance of the liquid jet head may be performed at this second position, compared with a structure in which a liquid jet head is moved to a service station or the like as in a conventional case, the manufacturing cost of the apparatus may be reduced. In addition, because the rotating shaft is disposed at the end portion in the first direction and in the second direction, the liquid jet head in rotation does not extend downward beyond the rotating shaft too much. Therefore, at the first position, the clearance to the recording medium may be set as small as possible to improve the print precision, while, at the second position, space below the liquid jet head may be effectively used.

### BRIEF DESCRIPTION OF THE DRAWINGS

FIG. 1 is a perspective view illustrating an ink jet recording apparatus according to an embodiment of the present invention.

FIG. 2 is a schematic structural view of the ink jet recording apparatus.

FIG. 3 is a front view of an ink jet head.

FIG. 4 is a schematic structural view of the ink jet head viewed from a right side.

FIG. 5 is a sectional view taken along the line I-I of FIG. 4.

FIG. 6 is an exploded perspective view of a head chip.

FIG. 7 is a perspective view of a rotating device at a horizontal jet position illustrating a state in which the rotating device is attached to the ink jet head.

FIG. 8 is a perspective view of the rotating device at the horizontal jet position illustrating a state in which the ink jet head is detached from the rotating device.

FIG. 9 are perspective views of a rotating unit.

FIG. 10 are perspective views of a base unit.

FIG. 11 are explanatory diagrams (side views) for illustrating rotating operation of the rotating device.

FIG. 12 are explanatory diagrams (perspective views) for illustrating rotating operation of the rotating device.

FIG. 13 are explanatory diagrams illustrating a method of filling ink into the ink jet heads arranged above a belt conveyor.

FIG. 14 shows graphs of a relationship among operation timing of a suction pump, operation timing of a pressure pump, and space (negative pressure chamber).

FIG. 15 are enlarged sectional views of a principal part of the head chip illustrating operation of initial filling.

### BEST MODE FOR CARRYING OUT THE INVENTION

Next, an embodiment according to the present invention is described with reference to the attached drawings.

### (Liquid Jet Recording Apparatus)

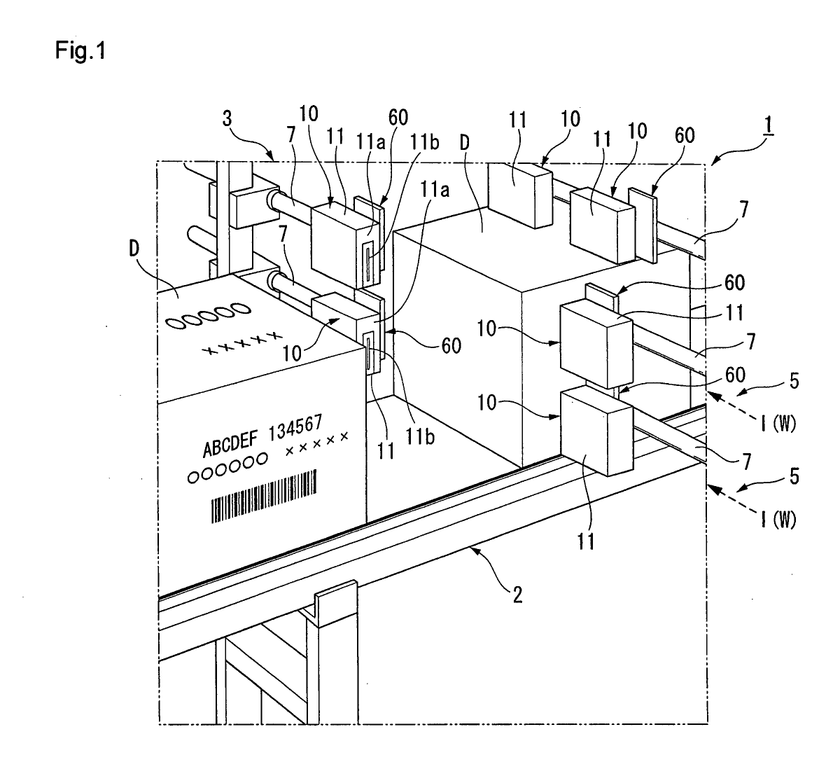

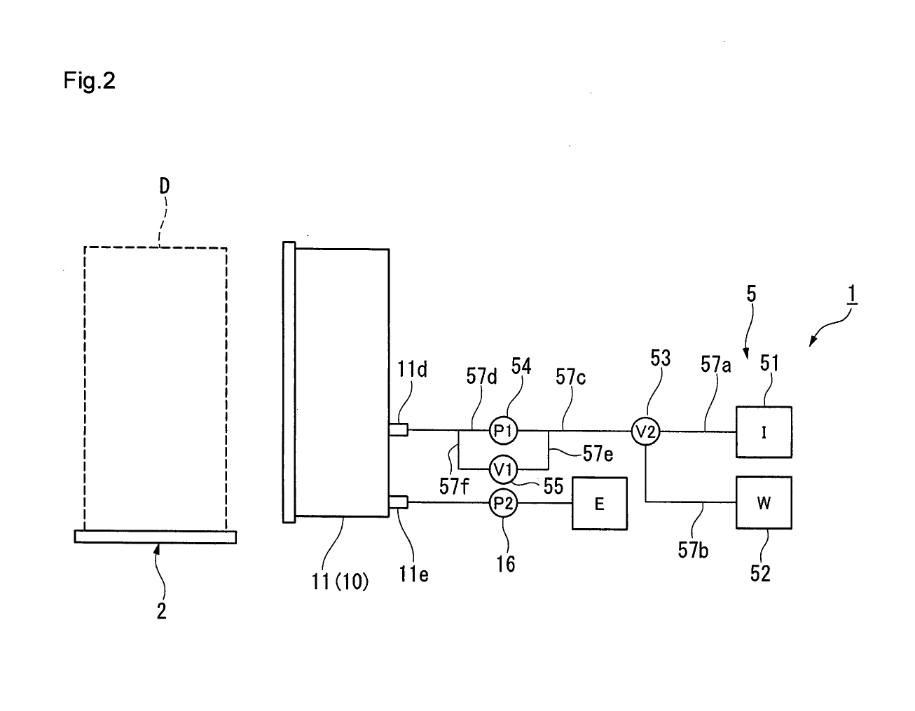

FIG. 1 is a perspective view illustrating an ink jet recording apparatus (liquid jet recording apparatus) 1 according to an embodiment of the present invention. FIG. 2 is a schematic structural view of the ink jet recording apparatus 1.

As illustrated in FIGS. 1 and 2, the ink jet recording apparatus 1 is connected to a predetermined personal computer (not shown), and carries out printing on a box D by, based on print data sent from the personal computer, discharging (jetting) ink (liquid) I. The ink jet recording apparatus 1 includes a belt conveyor 2 for transferring the box D in one direction, an ink discharging portion 3 including a plurality of ink jet heads (liquid jet heads) 10, an ink supply portion 5 for, as illustrated in FIG. 2, supplying the ink I and a cleaning liquid W to the ink jet head 10, and a suction pump (suction portion) 16 connected to the ink jet head 10.

The ink discharging portion 3 discharges the ink I to the box D, and, as illustrated in FIG. 1, includes two ink jet heads 10 in the shape of rectangular parallelepipeds on one side of the belt conveyor 2, on the other side of the belt conveyor 2, and above the belt conveyor 2, respectively, (six in total) with the box D sandwiched therebetween. The ink jet heads 10 are arranged under a state in which ink discharge surfaces 11a of respective cases 11 are oriented to the belt conveyor 2 side (box D), respectively. It is to be noted that two of the ink jet heads 10 disposed on both sides of the belt conveyor 2 in the width direction are vertically aligned with other two of the ink jet heads 10 and the four ink jet heads 10 are supported by support members 7 via rotating devices 60 to be described later, respectively. The other two of the ink jet heads 10 disposed above the belt conveyor 2 are provided side by side along the width direction of the belt conveyor 2 and are supported by one support member 7 via rotating devices 60.

### (Liquid Jet Head)

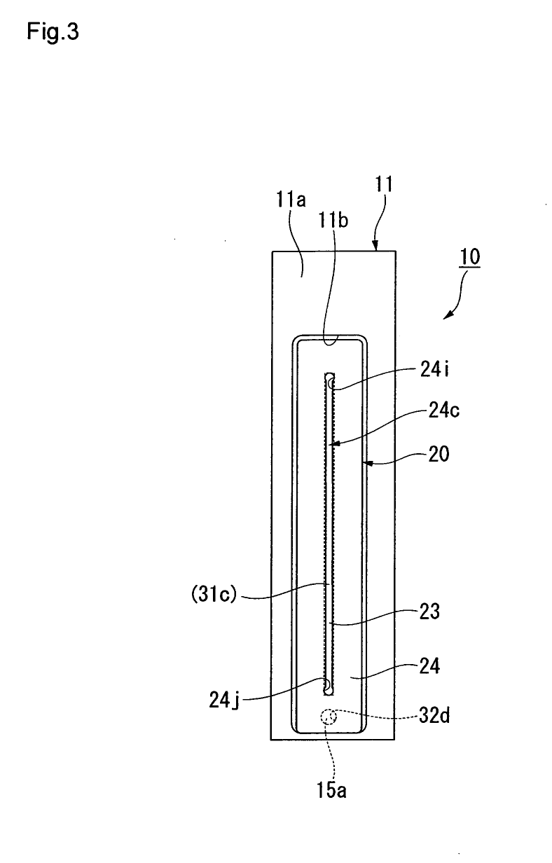

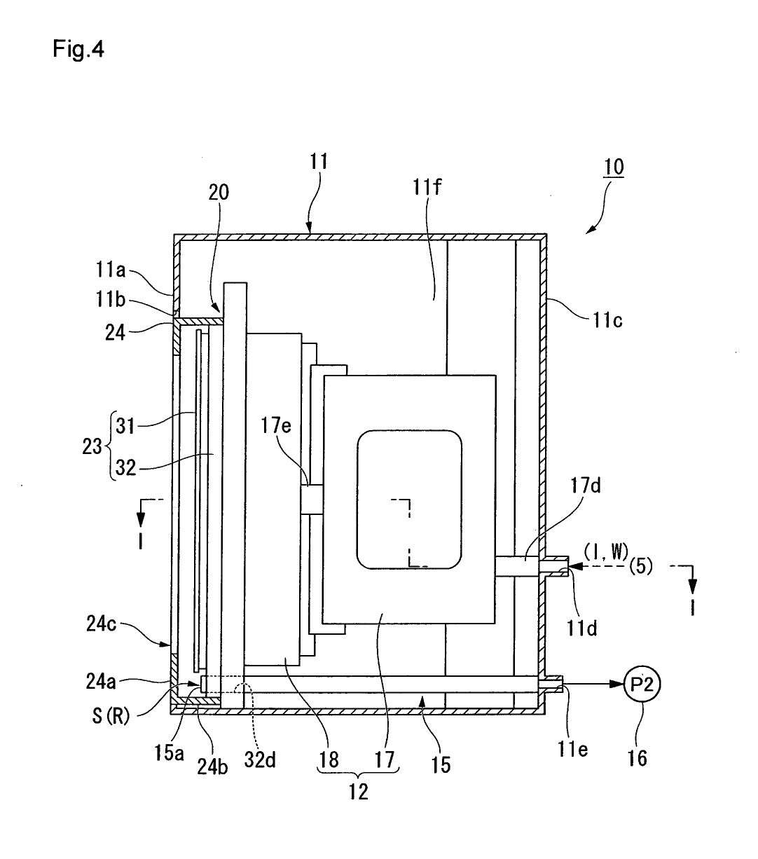

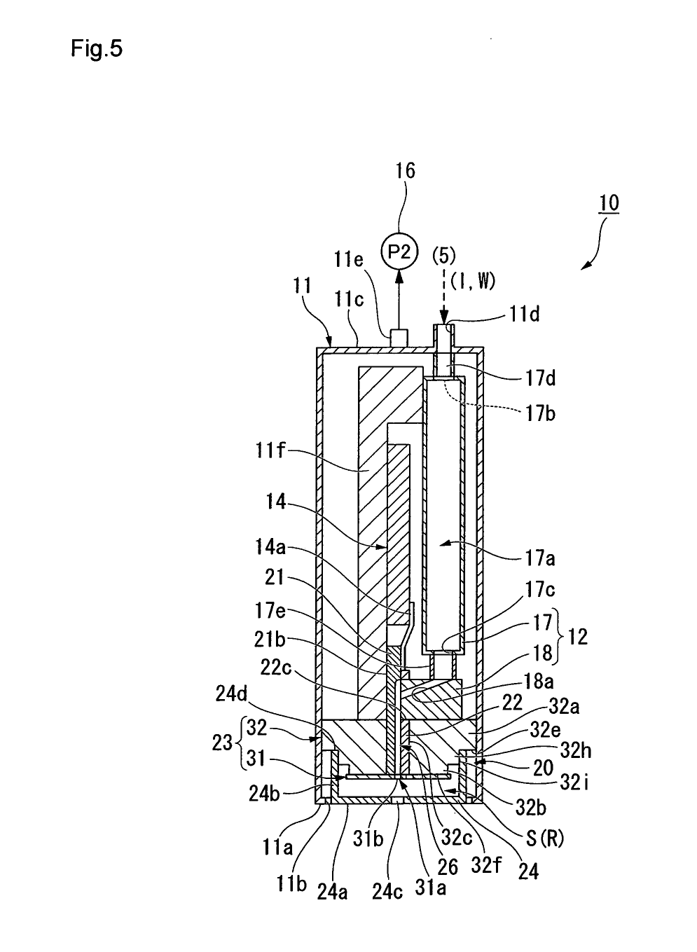

FIG. 3 is a front view of the ink jet head 10. FIG. 4 is a schematic structural view of the ink jet head 10 viewed from a right side. FIG. 5 is a sectional view taken along the line I-I of FIG. 4. It is to be noted that, in the following description of the ink jet head 10, a case in which the ink jet head 10 is at a horizontal jet position to be described later is described as an example.

As illustrated in FIG. 4, the ink jet head 10 includes the case 11 described above, a liquid supply system 12, a head chip 20, a drive circuit board 14 (see FIG. 5), and a suction flow path 15.

As illustrated in FIGS. 4 and 5, the case 11 is in the shape of a thin box having an opening 11b formed in a lower portion of the ink discharge surface 11a thereof, and two through holes for communicating with internal space are formed along a height direction in a back surface 11c thereof. More specifically, an ink injection hole 11d is formed in a substantially middle portion in the height direction, and an ink suction hole 11e is formed in a lower portion in the height direction. The case 11 includes, in the internal space thereof, a base plate 11f fixed to the case 11 so as to be upright, and houses structural items of the ink jet head 10.

The liquid supply system 12 communicates with the ink supply portion 5 via the ink injection hole 11d, and substantially formed of a damper 17 and an ink flow path substrate 18.

As illustrated in FIG. 5, the damper 17 is for the purpose of adjusting pressure fluctuations of the ink I, and includes a storing chamber 17a for storing the ink I. The damper 17 is fixed to the base plate 11f and includes an ink intake hole 17b connected to the ink injection hole 11d via a tube member 17d and an ink outflow hole 17c connected to the ink flow path substrate 18 via a tube member 17e.

The ink flow path substrate 18 is, as illustrated in FIG. 4, a member formed so as to be vertically long, and, as illustrated in FIG. 5, a member having a circulation path 18a formed therein, which communicates with the damper 17 and through which the ink I passes, and is attached to the head chip 20.

As illustrated in FIG. 5, the drive circuit board 14 includes a control circuit (not shown) and a flexible substrate 14a. The drive circuit board 14 applies voltage to a ceramic piezoelectric plate (actuator) 21 according to a print pattern with one end of the flexible substrate 14a being joined to plate-like electrodes (not shown) to be described later and the other end being joined to a control circuit (not shown) on the drive circuit board 14. The drive circuit board 14 is fixed to the base plate 11f.

### (Head Chip)

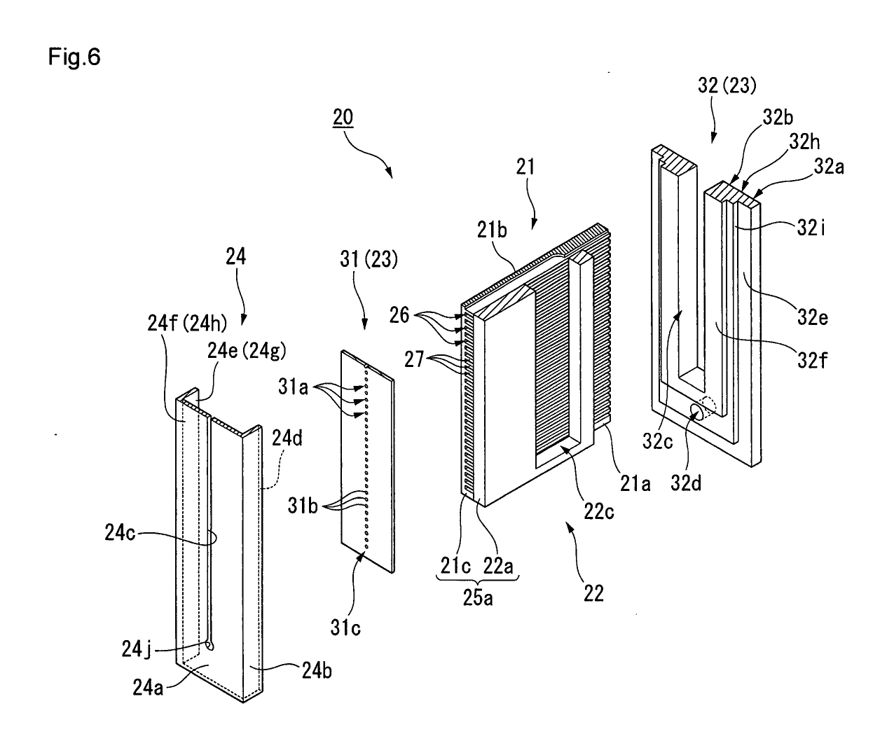

FIG. 6 is an exploded perspective view of the head chip 20.

As illustrated in FIG. 6, the head chip 20 includes the ceramic piezoelectric plate 21, an ink chamber plate 22, a nozzle body (jetting body) 23, and a nozzle guard (jetting body guard) 24.

The ceramic piezoelectric plate 21 is a substantially rectangular plate-like member formed of lead zirconate titanate (PZT) and has a plurality of long grooves (pressure generating chambers) 26 provided on one plate surface 21a of two plate surfaces 21a and 21b thereof so as to be stacked on top of one another, and the respective long grooves 26 are isolated from one another by side walls 27.

The long grooves 26 are provided so as to extend in a direction of a short side of the ceramic piezoelectric plate 21, and the plurality of long grooves 26 are provided so as to be stacked on top of one another over the whole length in a direction of a long side of the ceramic piezoelectric plate 21. The plurality of side walls 27 are provided so as to be stacked on top of one another over the long side of the ceramic piezoelectric plate 21 for partitioning into the long grooves 26. Plate-like electrodes (not shown) for applying drive voltage are provided on both wall surfaces of the side walls 27 on the opening side of the long grooves 26 (on the plate surface 21a side) so as to extend in the direction of the short side of the ceramic piezoelectric plate 21. The above-mentioned flexible substrate 14a is joined to the plate-like electrodes.

As illustrated in FIG. 5, a portion of the plate surface 21b on the back side surface side of the ceramic piezoelectric plate 21 is fixed to an edge portion of the base plate 11f, and the long grooves 26 extend toward the opening 11b.

Further, the ink chamber plate 22 is, similarly to the ceramic piezoelectric plate 21, a substantially rectangular plate-like member. Compared with the size of the ceramic piezoelectric plate 21, the ink chamber plate 22 is formed so that its size in the direction of the long side is substantially the same as that of the ceramic piezoelectric plate 21 and its size in the direction of the short side is smaller than that of the ceramic piezoelectric plate 21. The ink chamber plate 22 includes an open hole 22c which passes through the thickness and which is formed over the long side of the ink chamber plate 22.

The ink chamber plate 22 is joined to the ceramic piezoelectric plate 21 from the plate surface 21a side so that a front side surface 22a thereof and the front side surface 21c of the ceramic piezoelectric plate 21 are flush with each other and form an abutting surface 25a. In this joined state, the open hole 22c exposes the whole of the plurality of long grooves 26 of the ceramic piezoelectric plate 21, all the long grooves 26 are open to the outside, and the respective long grooves 26 are in a communicating state.

As illustrated in FIG. 5, the ink flow path substrate 18 is attached to the ink chamber plate 22 so as to cover the open hole 22c. The circulation path 18a in the ink flow path substrate 18 communicates with the respective long grooves 26.

As illustrated in FIG. 5, the nozzle body 23 is formed by sticking a nozzle plate 31 to a nozzle cap 32.

As illustrated in FIG. 6, the nozzle plate 31 is a thin-plate-like, strip-like member formed of polyimide, and a plurality of nozzle holes 31a which pass through the thickness thereof line up to form a nozzle column 31c. More specifically, the nozzle holes 31a the number of which is the same as that of the long grooves 26 are formed in line at the middle in the direction of the short side of the nozzle plate 31 at the same intervals as those of the long grooves 26. It is to be noted that a water-repellent film which is water-repellent for the purpose of preventing adhesion of ink and the like is applied to, of two plate surfaces of the nozzle plate 31, a plate surface to which orifices (nozzles) 31b for discharging the ink I are open, while the other plate surface is a surface to which the abutting surface 25a and the nozzle cap 32 are joined.

The nozzle cap 32 is a member in the shape of a frame-plate-like member with an outer periphery of one of two frame surfaces being cut away, and is a member including a thin-plate-like outer frame portion 32a, a middle frame portion 32h which is thicker than the outer frame portion 32a, an inner frame portion 32b which is thicker than the middle frame portion 32h, a long hole 32c which passes through the thickness at the middle portion in the direction of the short side of the inner frame portion 32b and which extends in the direction of the long side, and a discharge hole 32d which passes through the thickness at an end portion of the middle frame portion 32h. In other words, the middle frame portion 32h and the inner frame portion 32b protrude in the thickness direction from an outer frame surface 32e of the outer frame portion 32a so as to be step-like so that the contour of a section in the thickness direction is like stairs in which the heights of the outer frame portion 32a, the middle frame portion 32h, and the inner frame portion 32b become larger in this order toward the long hole 32c.

The nozzle plate 31 is stuck to an inner frame surface 32f which extends in the same direction as the outer frame surface 32e so as to block the long hole 32c. The outer frame surface 32e is in abutting contact with the ring-shaped end portion 24d of the nozzle guard 24.

The nozzle body 23 is housed in the internal space of the case 11 so that the discharge hole 32d of the nozzle cap 32 is located on a lower side (see FIG. 3), and is fixed to the case 11 and the base plate 11f (see FIG. 5). In this state, a part of the ceramic piezoelectric plate 21 and a part of the ink chamber plate 22 are inserted in the long hole 32c and the nozzle plate 31 is in abutment with the abutting surface 25a. Further, the nozzle plate 31 is adhered to the inner frame surface 32f by an adhesive. Compared with the area of the inner frame surface 32f, the area of the nozzle plate 31 is formed so as to be larger, and the nozzle plate 31 is disposed so as to extend beyond the edges of the inner frame surface 32f to some extent.

In such a structure, when a predetermined amount of the ink I is supplied from the storing chamber 17a in the damper 17 to the ink flow path substrate 18, the supplied ink I is fed via the open hole 22c into the long grooves 26.

### (Nozzle Guard)

As illustrated in FIGS. 4 to 6, the nozzle guard 24 is a member substantially in the shape of a box formed of stainless steel, and is formed by press forming. The nozzle guard 24 includes a top plate portion 24a formed so as to be rectangular-plate-like, and an airtight portion 24b which extends from a peripheral portion of the top plate portion 24a in a direction substantially orthogonal to a surface of the plate.

The top plate portion 24a includes a slit 24c which extends in the direction of a long side thereof at the middle portion in the direction of a short side thereof. The slit 24c is formed so as to be a little longer than the nozzle column 31c, and both end portions (upper end portion 24i and lower end portion 24j) thereof are formed in the shape of a circle.

The width dimension of the slit 24c is set to be about 1.5 mm while the nozzle diameter of the nozzle holes 31a is 40 μm. The width dimension of the slit 24c is desirably set so that the upper limit thereof is the largest size at which the suction pump 16 can generate negative pressure and the lower limit thereof is the smallest size at which, in the initial filling of the ink I, the ink I does not overflow from the slit 24c to droop. It is to be noted that the upper end portion 24i and the lower end portion 24j are formed in the shape of a circle the diameter of which is a little larger than the above-mentioned width dimension.

As illustrated in FIG. 6, a hydrophilic film 24g is formed by titanium coating on an inward inner surface 24e of the nozzle guard 24, while a water-repellent film 24h is formed by fluorine resin coating or Teflon (registered trademark) plating on an outer surface 24f on a back surface of the inner surface 24e and on an inner surface of the slit 24c.

The ring-shaped end portion 24d of the nozzle guard 24 is adhered to the outer frame surface 32e with an adhesive so that the top plate portion 24a covers the inner frame portion 32b and the discharge hole 32d (see FIG. 3) and so that the inner surface 24e of the airtight portion 24b and a middle side surface 32i of the middle frame portion 32h are in abutting contact with each other. In this way, the nozzle guard 24 is attached to the nozzle cap 32 so as to cover the nozzle cap 32 (see FIG. 5). In this state, the nozzle guard 24 covers the nozzle column 31c via space (inside space) S so that the slit 24c is opposed to the nozzle column 31c and so that the slit 24c is not opposed to the discharge hole 32d. It is to be noted that the distance between the top plate portion 24a of the nozzle guard 24 and the nozzle plate 31 is desirably set so that the upper limit thereof is the largest distance at which the suction pump 16 can generate negative pressure and the lower limit thereof is the smallest distance at which, in the initial filling of the ink I, the ink I does not overflow from the slit 24c.

As illustrated in FIG. 4, the above-mentioned suction flow path 15 is formed by fitting and inserting one end of a tube to be the suction port 15a in the discharge hole 32d to be fixed and connecting the other end to the ink suction hole 11e. As described above, the suction port 15a is opened to a location which is not opposed to the slit 24c.

Further, the suction pump 16 is connected to the ink suction hole 11e via a tube. In operation, the suction pump 16 sucks air and the ink I in the space S to cause the space S to become a negative pressure chamber R. It is to be noted that the suction pump 16 stores the sucked ink I in a waste liquid tank E (see FIG. 2).

Reference is made again to FIG. 2. The ink supply portion 5 includes an ink tank 51 in which the ink I is stored, a cleaning liquid tank 52 in which the cleaning liquid W is stored, a changeover valve 53 which can switch between two flow paths, a pressure pump 54 which supplies the ink I or the cleaning liquid W to the ink jet head 10 in a pressurized state, and an open/close valve 55 which can open and close the flow paths.

The ink tank 51 and the cleaning liquid tank 52 communicate with the pressure pump 54 via a supply tube 57a, the changeover valve 53, and a supply tube 57c, and via a supply tube 57b, the changeover valve 53, and the supply tube 57c, respectively. More specifically, the supply tubes 57a and 57b as inflow tubes and the supply tube 57c as an outflow tube are connected to the changeover valve 53.

The pressure pump 54 is connected to the supply tube 57c and communicates with the ink jet head 10 via a supply tube 57d, and supplies the ink I or the cleaning liquid W, which flows in from the supply tube 57c, to the ink jet head 10. The pressure pump 54 is formed not to allow fluid to flow therethrough in a non-operating state, and has a function like an open/close valve.

The open/close valve 55 is connected to a supply tube 57e which communicates with the supply tube 57c to be an inflow tube and to a supply tube 57f which communicates with the supply tube 57d to be an outflow tube. More specifically, when the open/close valve 55 is opened, the supply tubes 57e and 57f function as a bypass of the pressure pump 54.

### (Rotating Device)

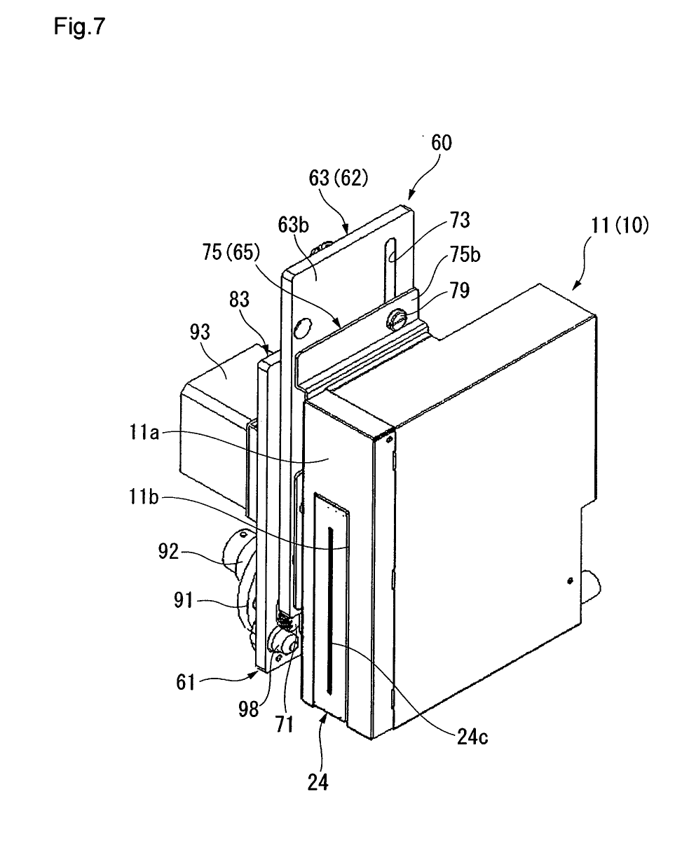

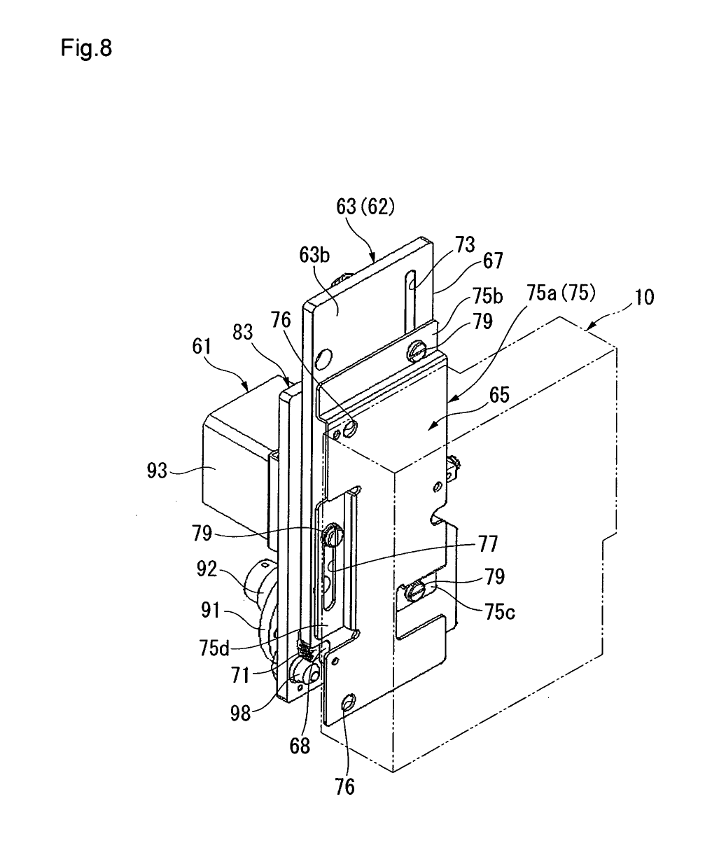

FIG. 7 is a perspective view of a rotating device 60 at a horizontal jet position illustrating a state in which the rotating device 60 is attached to the ink jet head 10. FIG. 8 is a perspective view of the rotating device 60 at the horizontal jet position illustrating a state in which the ink jet head 10 is detached from the rotating device 60.

Here, as illustrated in FIGS. 1, 7, and 8, the ink jet head 10 according to this embodiment is supported by the above-mentioned support member 7 (see FIG. 1) via the rotating device 60. More specifically, as illustrated in FIG. 1, the ink jet heads 10 arranged on both sides of the belt conveyor 2 in the width direction are arranged so as to be opposed to side surfaces of the box D which is transferred on the belt conveyor 2 under a state in which the direction of openings of the openings 11b (orifices 31b) in the ink discharge surface 11a is horizontal (horizontal jet position: second position). On the other hand, the ink jet heads 10 arranged above the belt conveyor 2 are arranged so as to be opposed to an upper surface of the box D which is transferred on the belt conveyor 2 under a state in which the direction of openings of the openings 11b (orifices 31b) is the direction of gravity (downward jet position: first position). Further, with regard to each of the ink jet heads 10 arranged above the belt conveyor 2, an end portion of the ink discharge surface 11a of the case 11 is substantially aligned with an edge between the upper surface and a side surface of the box D.

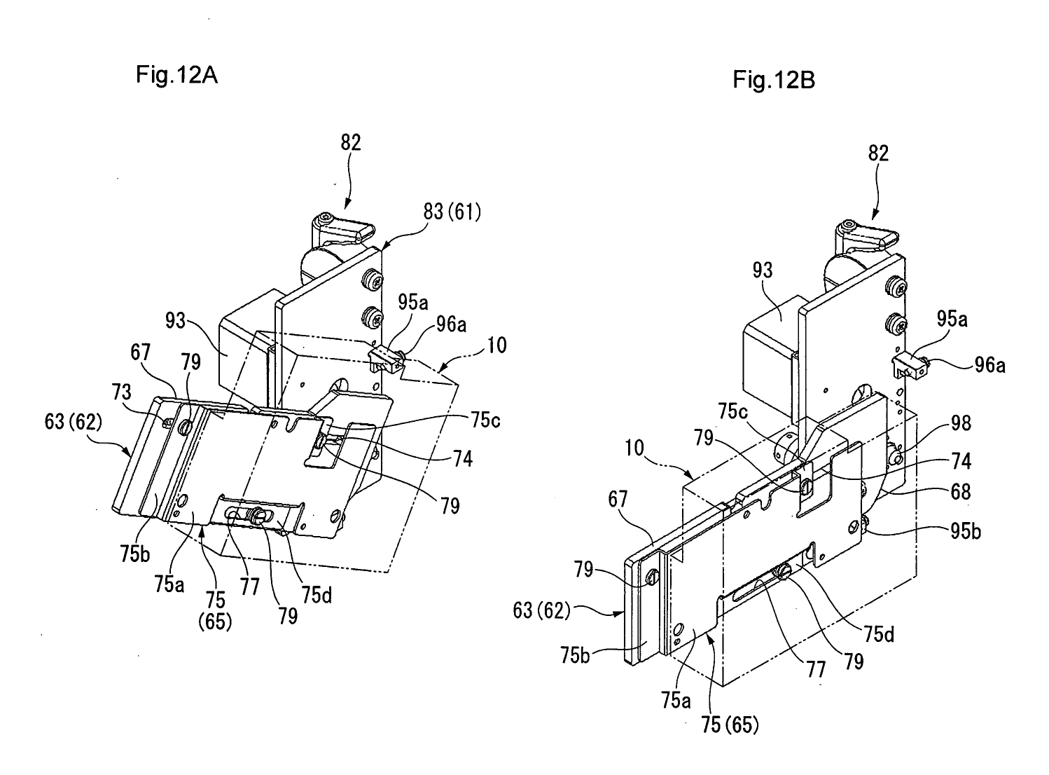

As illustrated in FIGS. 7 and 8, the rotating device 60 rotates the ink jet head 10 attached thereto between the downward jet position (see FIG. 12(b)) for discharging the ink I downward (in the first direction) under a state in which the direction of openings of the orifices 31b in the nozzle plate 31 (see FIG. 5) is the direction of gravity and the horizontal jet position for discharging the ink I sideways (in the second direction) under a state in which the direction of openings of the orifices 31b is horizontal. It is to be noted that, in the following description of the rotating device 60, the ink jet head 10 is at the horizontal jet position.

The rotating device 60 is substantially formed of a base unit 61, a rotating unit 62 which is rotatable with respect to the base unit 61, and a slide mechanism 65 which supports the ink jet head 10, which is provided on a rotating plate 63 of the rotating unit 62, and which is slidable with respect to the rotating plate (rotating member) 63.

### (Rotating Unit)

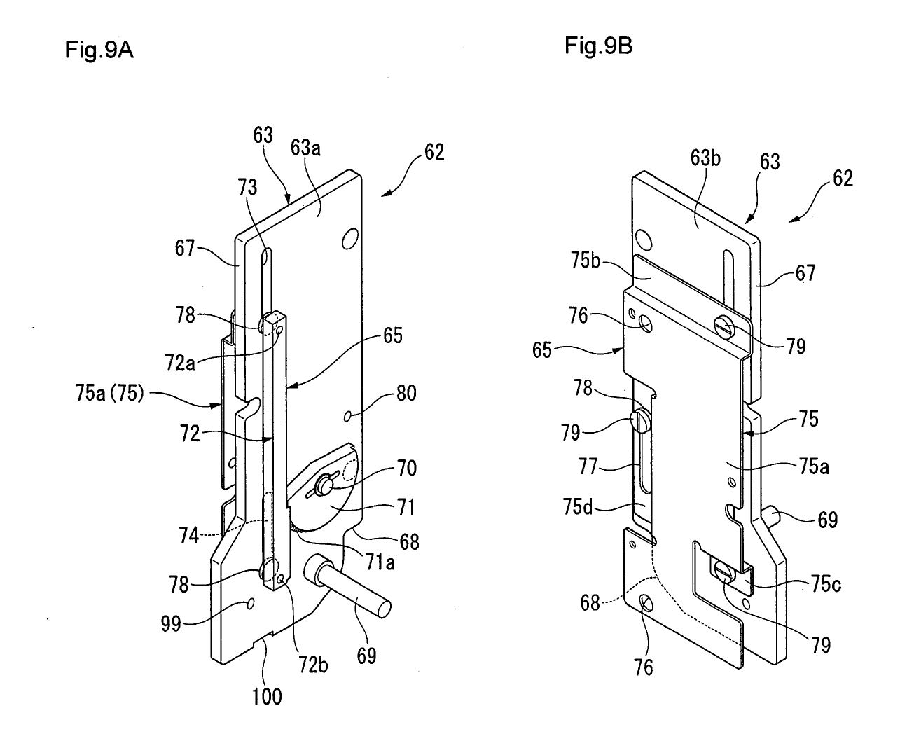

FIG. 9 are perspective views of the rotating unit 62. FIG. 9(a) illustrates a state viewed from an outer surface side and FIG. 9(b) illustrates a state viewed from an inner surface side.

As illustrated in FIG. 9(a), the rotating unit 62 includes the rotating plate 63 which is rotatably supported by the base unit 61. The rotating plate 63 is formed of a metal material such as aluminum in the shape of a rectangle seen in plan view, and has a cutout portion 67 formed therein which is cut out in a direction of a long side from a corner portion on one side (hereinafter, referred to as rear side) of an upper portion thereof, and a cutout portion 68 formed therein which is cut out from a corner portion on the other side (hereinafter, referred to as front side) of a lower portion thereof. The cutout portion 68 is for the purpose of preventing, when the rotating unit 62 rotates, the rotating unit 62 from protruding downward with respect to the base unit 61.

A rotating shaft 69 extending in the thickness direction of the rotating plate 63 is provided so as to be upright from the vicinity of the cutout portion 68 on an outer surface 63a side of the rotating plate 63, that is, from an end portion in the lower portion in the direction of the long side and on the front side in a width direction of the rotating plate 63. The rotating shaft 69 is a center of rotation of the rotating unit 62, and the rotating plate 63 rotates about the rotating shaft 69 with respect to the base unit 61. It is to be noted that, although it is enough that the above-mentioned end portion is in a portion which is lower than and on the front side of a middle portion of the rotating plate 63, in order to suppress downward protrusion of the rotating unit 62 in rotation, it is preferred that the rotating shaft 69 be set to be in a portion which is as low as possible and which is on the front side to the extent possible of the rotating plate 63.

Above the rotating shaft 69, a pin 70 is provided upright so as to protrude in parallel with the direction of extension of the rotating shaft 69. The pin 70 is formed so as to have a length which is smaller than the length of the rotating shaft 69, and a rocking gear 71 is provided for the pin 70. The rocking gear 71 is a so-called sector gear in which gear teeth 71a are formed on an arc portion of a sector plate and which is engaged with a rack member 72 to be described later.

Further, a plurality of guide holes (first guide hole 73 and second guide hole 74) which pass through the thickness of the rotating plate 63 are formed on the rear side of the rotating plate 63. The first guide hole 73 is a long hole formed in the upper portion of the rotating plate 63, a major axis of which is in the direction of the long side of the rotating plate 63. The second guide hole 74 is a long hole formed in the lower portion of the rotating plate 63, a major axis of which is in the direction of the long side of the rotating plate.

As illustrated in FIG. 9(b), a head attaching plate (slide member) 75 is supported on an inner surface 63b side of the rotating plate 63 so as to be slidable with respect to the rotating plate 63 in a direction of a radius of the rotating shaft 69. The head attaching plate 75 is formed of a plate of a metal material by press working or the like, and is formed so that the length in a direction of a short side of the head attaching plate 75 is substantially the same as that in the direction of a short side of the rotating plate 63 and so that the length in a direction of a long side of the head attaching plate 75 is a little smaller than that in the direction of the long side of the rotating plate 63. The head attaching plate 75 includes an attaching plate body 75a which is disposed in parallel with the rotating plate 63 with space to some extent to the inner surface 63b of the rotating plate 63, and a plurality of L-shaped angle portions (first L-shaped angle portion 75b, second L-shaped angle portion 75c, and third L-shaped angle portion 75d) formed by bending an upper portion and both sides, respectively, of the attaching plate body 75a to be coupled to the rotating plate 63.

Through holes 76 which pass through the thickness of the attaching plate body 75a are formed in the upper portion and a lower portion, respectively, on the front side of the attaching plate body 75a. The case 11 of the ink jet head 10 and the attaching plate body 75a are fastened and fixed to each other by inserting bolts (not shown) into the through holes 76.

The first L-shaped angle portion 75b is formed by bending an upper edge of the head attaching plate 75, and a proximal end side thereof is bent by about 90 degrees toward the rotating plate 63 while a distal end side thereof is bent by 90 degrees so as to be in parallel with the inner surface 63b of the rotating plate 63. An attaching circular hole (not shown) which passes through the thickness of the first L-shaped angle portion 75b is formed on a rear side of the first L-shaped angle portion 75b at a location which is aligned with the above-mentioned first guide hole 73.

On the other hand, the second L-shaped angle portion 75c is formed by cutting out the end side in the direction of a short side on a lower portion side in the direction of a long side of the head attaching plate 75, and, similarly to the case of the first L-shaped angle portion 75b, a proximal end side of the head attaching plate 75 is bent by about 90 degrees toward the rotating plate 63 while a distal end side thereof is bent by 90 degrees so as to be in parallel with the inner surface 63b of the rotating plate 63. Further, an attaching circular hole (not shown) which passes through the thickness of the second L-shaped angle portion 75c is formed at a location which is aligned with the above-mentioned second guide hole 74.

Further, the third L-shaped angle portion 75d is formed by cutting out the front side in the direction of the short side in a middle portion in the direction of the long side of the head attaching plate 75, and, similarly to the case of the first L-shaped angle portion 75b, a proximal end side of the head attaching plate 75 is bent by about 90 degrees toward the rotating plate 63 while a distal end side thereof is bent by 90 degrees so as to be in parallel with the inner surface 63b of the rotating plate 63. Further, an attaching long hole 77 which passes through the thickness of the third L-shaped angle portion 75d is formed in the head attaching plate 75, a major axis of which is in the direction of a long side thereof.

As illustrated in FIG. 9(a), the rack member 72 is provided on a side opposite to the head attaching plate 75 with respect to the rotating plate 63, that is, on the outer surface 63a side of the rotating plate 63. The rack member 72 is in the shape of a rectangular bar, and includes a rack gear (not shown) formed on a lower end side thereof which is engaged with the gear teeth 71a in the rocking gear 71 described above. Screw holes 72a and 72b which pass through the thickness of the rack member 72 are formed in upper and lower portions, respectively, of the rack member 72.

Further, as illustrated in FIG. 9, the rack member 72 and the head attaching plate 75 are coupled to each other by screws 79 via washers 78 with the rotating plate 63 sandwiched therebetween. More specifically, a screw 79 is inserted from an attaching hole in the first L-shaped angle portion 75b of the head attaching plate 75 through the first guide hole 73 to be screwed in the screw hole 72a in the rack member 72, while another screw 79 is inserted from an attaching hole in the second L-shaped angle portion 75c through the second guide hole 74 to be screwed in the screw hole 72b in the rack member 72, by which the rack member 72 and the head attaching plate 75 are coupled to each other.

Similarly, still another screw 79 is inserted in the attaching long hole 77 in the third L-shaped angle portion 75d via another washer 78 to be screwed in a screw hole 80 formed in the rotating plate 63.

In this case, the screws 79 relatively slide on the guide holes 73 and 74 in the rotating plate 63 and on the attaching long hole 77 in the third L-shaped angle portion 75d, respectively, in the direction of the major axes thereof, by which the head attaching plate 75 is slidably supported along the direction of the long side of the rotating plate 63. The slide mechanism 65 according to this embodiment is formed by the rocking gear 71, the rack member 72, the head attaching plate 75, and the screws 79.

### (Base Unit)

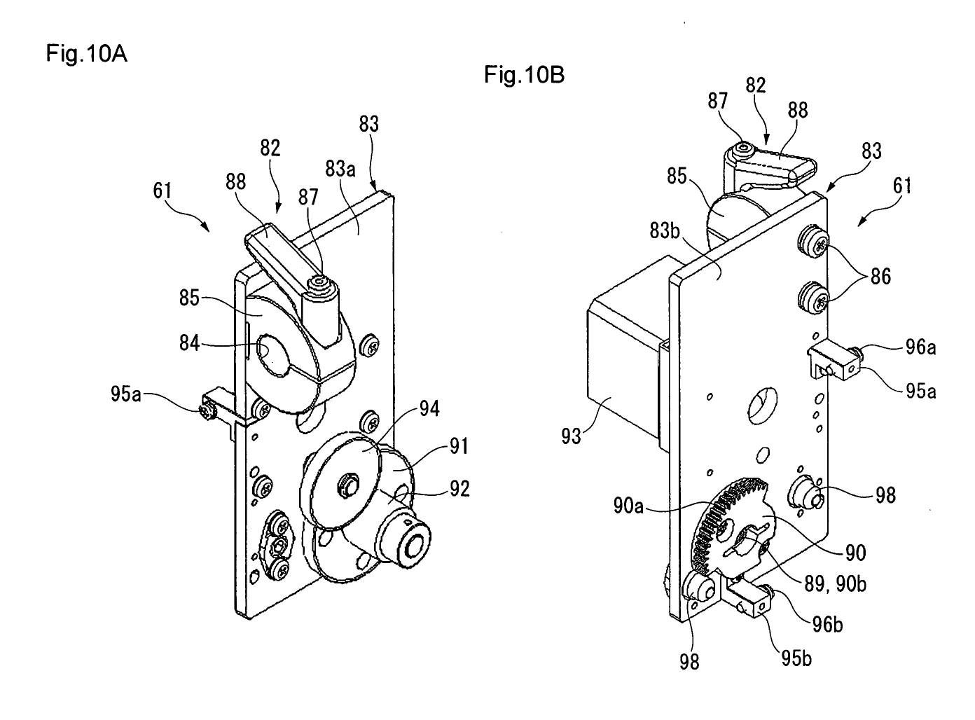

FIG. 10 are perspective views of the base unit 61. FIG. 10(a) illustrates a state viewed from the outer surface side and FIG. 10(b) illustrates a state viewed from the inner surface side. It is to be noted that, in FIG. 10(a), for the sake of easy understanding, a motor unit to be described later is omitted.

As illustrated in FIG. 10(a), the base unit 61 includes a base plate 83 which is fixed to the support member 7 via a joint 82. The base plate 83 is in the shape of a flat rectangular plate formed of a metal material such as aluminum, and the joint 82 is coupled to an upper portion on an outer surface 83a side thereof. The joint 82 includes a ring portion 85 having an insert hole 84 through which the above-mentioned support member 7 may be inserted. The ring portion 85 is fastened and fixed by screws 86 inserted from an inner surface 83b side of the base plate 83 under a state in which an axial direction of the ring portion 85 is the direction of a short side of the base plate 83.

A part of the ring portion 85 in a peripheral direction is cut out, and a bolt 87 for fastening end portions formed by cutting out the part is screwed through the end portions. A lever member 88 is fixed to the bolt 87. By rotating the lever member 88, the bolt 87 is moved in a fastening direction or in a releasing direction to reduce or increase an inside diameter of the insert hole 84 in the ring portion 85.

More specifically, by rotating the lever member 88 in the direction of fastening the bolt 87 under a state in which the support member 7 is inserted through the insert hole 84, the inside diameter of the insert hole 84 is reduced to enable reliable fixing of the base plate 83 to the support member 7. According to this embodiment, the base plate 83 is fixed to the support member 7 under a state in which the direction of a long side thereof is the direction of gravity (see FIG. 1). On the other hand, by rotating the lever member 88 in the direction of releasing the bolt 87, the inside diameter of the insert hole 84 is increased to enable pulling of the support member 7 out of the joint 82, and thus, the base plate 83 may be easily detached from the support member 7.

A through hole 89 which passes through the thickness of the base plate 83 is formed in a corner portion on the front side of a lower portion of the base plate 83. The through hole 89 is a hole for the purpose of inserting therethrough the above-mentioned rotating shaft 69 on the rotating plate 63, and a fixed gear 90 is fixed on the inner surface 83b side of the base plate 83 so as to be aligned with the through hole 89. The fixed gear 90 is a sector gear in which gear teeth 90a are formed like an arc, and has a through hole 90b formed therein at a location which is aligned with the through hole 89 in the base plate 83. The fixed gear 90 is fastened and fixed to the inner surface of the base plate 83 by a screw (not shown). The gear teeth 90a in the fixed gear 90 and the above-mentioned gear teeth 71a in the rocking gear 71 are engageable with each other. In other words, the rack member 72 and the fixed gear 90 are coupled to each other with the rocking gear 71 sandwiched therebetween. It is to be noted that a bearing (not shown) for rotatably supporting the rotating shaft 69 on the rotating plate 63 is provided between the fixed gear 90 and the base plate 83.

The rotating shaft 69 on the rotating plate 63 is, after being inserted through the through hole 89 in the base plate 83, equipped with a gear 91 from the outer surface 83a side of the base plate 83. The gear 91 is coupled to the rotating shaft 69 via a torque limiter 92. The torque limiter 92 releases the coupling between the rotating shaft 69 and the gear 91 when torque acting on the rotating shaft 69 is equal to or higher than a predetermined value. When the coupling is released, driving force applied by a motor unit 93 is not transmitted to the rotating shaft 69. It is to be noted that, while a lower end of the head attaching plate 75 is flush with a lower end of the base plate 83, a lower end of the rotating plate 63 is higher than the lower end of the base plate 83.

Further, the motor unit (drive means) 93 for rotating the rotating unit 62 is provided on a substantially middle portion of the outer surface 83a of the base plate 83. A transmission gear 94 which is engaged with a motor gear (not shown) of the motor unit 93 and with the gear 91 is provided between the motor unit 93 and the gear 91 so that driving force applied by the motor unit 93 is transmitted to the gear 91. The rotating plate 63 is rotated, by driving force applied by the motor unit 93, by about 90 degrees with respect to the base plate 83 with the rotating shaft 69 being the center of rotation.

Further, a stopper 95a which protrudes in a thickness direction of the base plate 83 is provided in the middle portion on the rear side on the inner surface 83b of the base plate 83. When the rotating unit 62 rotates from the downward jet position to the horizontal jet position, the stopper 95a is brought in abutment with an end surface of the cutout portion 67 in the rotating plate 63 (see FIG. 9(a)) to restrict the range of rotation of the rotating plate 63. Similarly, a stopper 95b is provided at the lower edge on the inner surface 83b of the base plate 83. When the rotating unit 62 rotates from the horizontal jet position to the downward jet position, the stopper 95b is brought in abutment with an end surface of the cutout portion 68 in the rotating plate 63 to restrict the range of rotation of the rotating plate 63. More specifically, screws 96a and 96b are screwed in the stoppers 95a and 95b, respectively, in the direction of the short side of the base plate 83 so that heads of the screws 96a and 96b are brought in abutment with the end surfaces of the cutout portions 67 and 68, respectively. In other words, by adjusting the amounts of the protrusion of the screws 96a and 96b from the stoppers 95a and 95b, respectively, fine adjustments of the range of rotation of the rotating plate 63 may be made.

Further, a plurality of (for example, two) plungers 98 are provided in a lower portion on the inner surface 83b of the base plate 83. The plungers 98 are so-called ball plungers and are fit in a fitting hole 99 formed in the outer surface 63a of the rotating plate 63 (see FIG. 9) at the downward jet position or at the horizontal jet position. By the fitting by the plungers 98 between the base unit 61 and the rotating plate 63 when the ink jet head 10 is at the downward jet position or at the horizontal jet position in this way, the ink jet head 10 may be prevented from being misaligned to be reliably positioned. As a result, the direction of discharge of ink may be kept fixed to improve the print precision. It is to be noted that a slanted surface 100 for helping the plungers 98 to ground on the base plate 83 when the rotation plate 63 rotates is formed at the lower edge of the rotation plate 63.

### (Rotating Operation of Rotating Device)

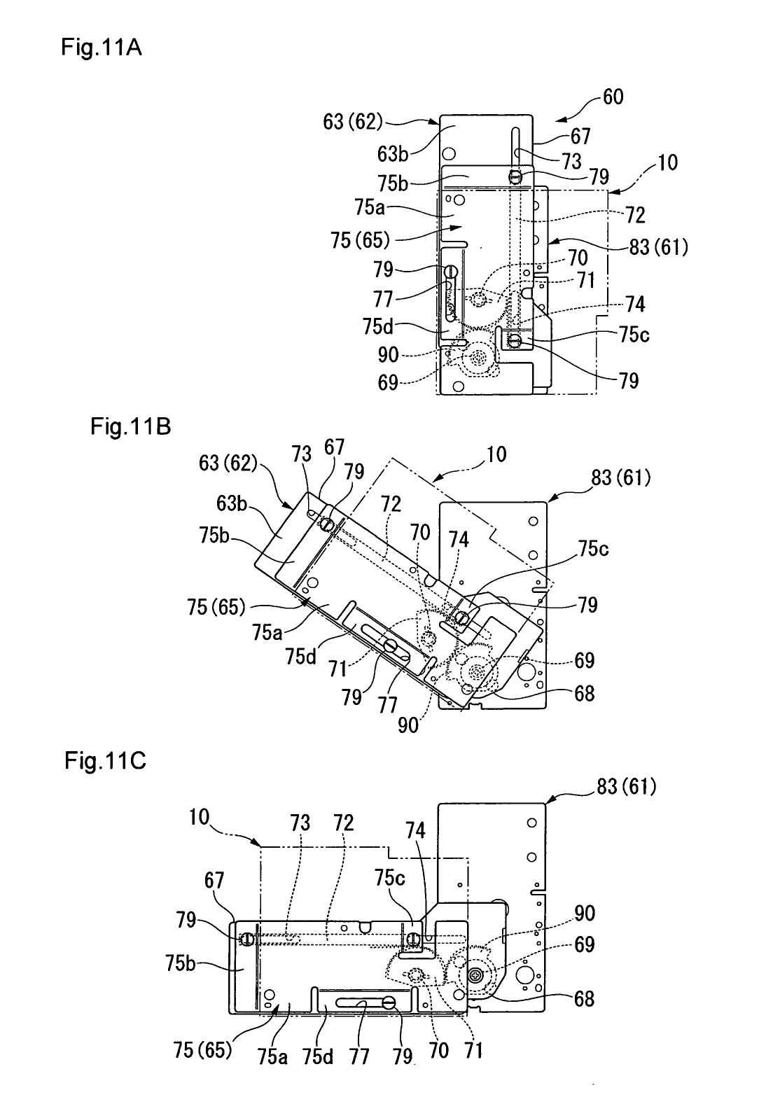

Next, rotating operation of the above-mentioned rotating device is described. FIGS. 11 and 12 are explanatory diagrams for illustrating the rotating operation of the rotating device according to this embodiment. FIG. 11 are side views and FIG. 12 are perspective views. First, rotating operation from the horizontal jet position to the downward jet position is described in the following.

As illustrated in FIGS. 8 and 11(a), first, when the rotating unit 62 is at the horizontal jet position, the direction of openings of the orifices 31b of the ink jet head 10 is horizontal. More specifically, the direction of the long side of the rotating plate 63 is the direction of the long side of the base plate 83, the screws 79 which are inserted through the guide holes 73 and 74 are located on one end (lower end) sides of the guide holes 73 and 74, respectively, and the screw 79 which is inserted though the attaching long hole 77 is located on the other end (upper end) side of the attaching long hole 77. Further, the center of rotation of the rotating unit 62 (rotating shaft 69) is disposed in proximity to a corner portion on the ink discharge surface 11a side of the ink jet head 10.

Here, when the motor unit 93 is driven, driving force applied by the motor unit 93 is transmitted via the transmission gear 94 to the gear 91 to rotate the gear 91. When the gear 91 is rotated, the rotating shaft 69 which is coupled to the gear 91 via the torque limiter 92 (see FIG. 10) rotates in synchronization therewith, and the rotating plate 63 begins to rotate so as to make a forward roll.

As illustrated in FIGS. 11(b) and 12(a), when the rotating plate 63 is rotated, in synchronization therewith, the rocking gear 71 which is engaged with the fixed gear 90 on the base plate 83 revolves around the fixed gear 90, and at the same time, rotates about the pin 70. Then, the rack member 72 which is engaged with the rocking gear 71 slides in the direction of the radius of the rotating shaft 69 (to the other end side in the direction of the long side of the rotating plate 63 (upward)). This causes the respective screws 79 of the slide mechanism 65 to relatively slide on the guide holes 73 and 74 and on the attaching long hole 77, which in turn causes the head attaching plate 75 to slide upward in the direction of the long side of the rotating plate 63. In this case, because the head attaching plate 75 slides upward while the rotating plate 63 is rotated, the head attaching plate 75 does not protrude downward beyond the lower end of the base plate 83 in rotation.

Then, as illustrated in FIGS. 11(c) and 12(b), when the rotating plate 63 continues to be rotated, the end surface of the cutout portion 68 in the rotating plate 63 is brought in abutment with the head of the screw 96b in the stopper 95b (see FIG. 10) and the plunger 98 fits in the fitting hole 99.

By the way, when the rotating plate 63 is brought in abutment with the stopper 95b and the rotation is restricted, torque acting on the rotating shaft 69 becomes higher than that in rotation. In response to this, according to this embodiment, by bringing the rotating plate 63 in abutment with the stopper 95b, the coupling between the gear 91 and the rotating shaft 69 via the torque limiter 92 is released so that driving force applied by the motor unit 93 is not transmitted to the rotating shaft 69. At the time when the coupling via the torque limiter 92 is released, the motor unit 93 stops. Because rotation of the rotating plate 63 stops at the time of being brought in abutment with the stopper 95b in this way, compared with a case in which drive means such as a pulse motor is used, rotation error may be suppressed. This may prevent the motor unit 93 from being overloaded and may reliably rotate the rotating plate 63 to the downward jet position or to the horizontal jet position to improve the print precision.

In the way described above, the rotating unit 62 is rotated by about 90 degrees from the horizontal jet position to the downward jet position. It is to be noted that, under a state in which the rotating unit 62 is at the downward jet position, the direction of openings of the orifices 31b of the ink jet head 10 is the direction of gravity. More specifically, the direction of the long side of the rotating plate 63 is orthogonal to the direction of the long side of the base plate 83, the screws 79 which are inserted through the guide holes 73 and 74 are located on the other end (front end) side of the guide holes 73 and 74, respectively, and the screw 79 which is inserted through the attaching long hole 77 is located on the one end (rear end) side of the attaching long hole 77. Further, the center of rotation of the rotating unit 62 (rotating shaft 69) is disposed so as to go outward a little beyond the corner portions on the ink discharge surface 11a side of the ink jet head 10.

### (Method of Filling Ink)

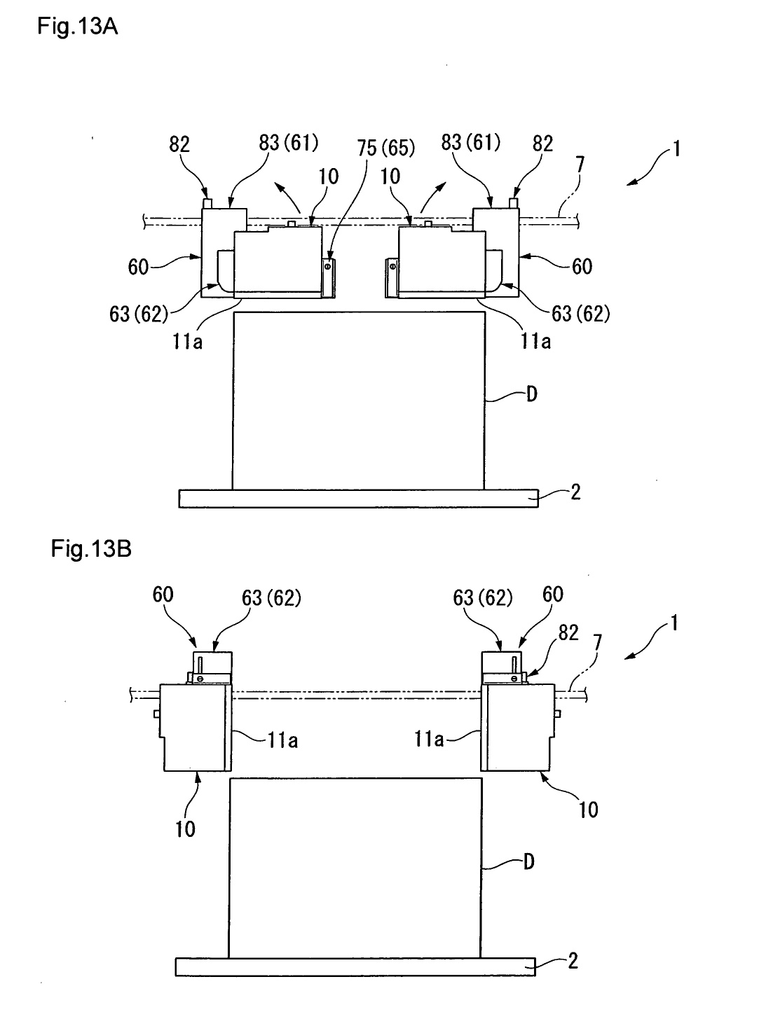

Next, a method of filling ink into the ink jet head 10 according to this embodiment is described. FIG. 13 are schematic structural views (front views) of the ink jet recording apparatus 1 and explanatory diagrams illustrating a method of filling ink into the ink jet heads 10 arranged above the belt conveyor 2. It is to be noted that, in the following description, mainly the method of filling ink into the ink jet head 10 arranged above the belt conveyor 2 is described. Therefore, in FIG. 13, the ink jet heads 10 arranged on both sides of the belt conveyor 2 are omitted.

A step of filling ink into the ink jet heads 10 according to this embodiment is performed under a state in which the ink jet heads 10 are at the horizontal jet position. Therefore, first, it is necessary to move the ink jet heads 10 which are at the downward jet position above the belt conveyor 2 to the horizontal jet position as illustrated in FIG. 13.

More specifically, first, as illustrated in FIGS. 11(c), 12(b), and 13(a), from the state in which the ink jet heads 10 are at the downward jet position, the motor units 93 are driven so as to be rotated in a direction reverse to that described above. Then, as described above, driving force applied by the motor units 93 is transmitted via the transmission gears 94 to the gears 91 to rotate the rotating shafts 69. This causes the rotating plates 63 to begin to rotate so as to make a backward roll with the rotating shafts 69 being the center of rotation (see arrows in FIG. 13(a)).

When the rotating plates 63 are rotated as described above, as illustrated in FIGS. 11(b) and 12(a), in synchronization therewith, the head attaching plates 75 slide toward the one end (rear end) side in the direction of the long side of the rotating plates 63. More specifically, as the rotating plates 63 are rotated, the head attaching plates 75 slide backward.

Then, as illustrated in FIGS. 7, 11(a), and 13(b), the rotating units 62 are rotated by about 90 degrees from the downward jet position to the horizontal jet position.

Here, the ink jet heads 10 are rotated so as to be retracted from over the box D which is transferred below the ink jet heads 10. More specifically, by the movement of the ink jet heads 10 which are arranged above the belt conveyor 2 to the horizontal jet position, the ink discharge surfaces 11a of the ink jet heads 10 are disposed away from both sides of side surfaces of the box D. Therefore, in the event of leakage of the ink I from the ink jet heads 10 in filling ink, the ink I does not adhere to the box D or the like.

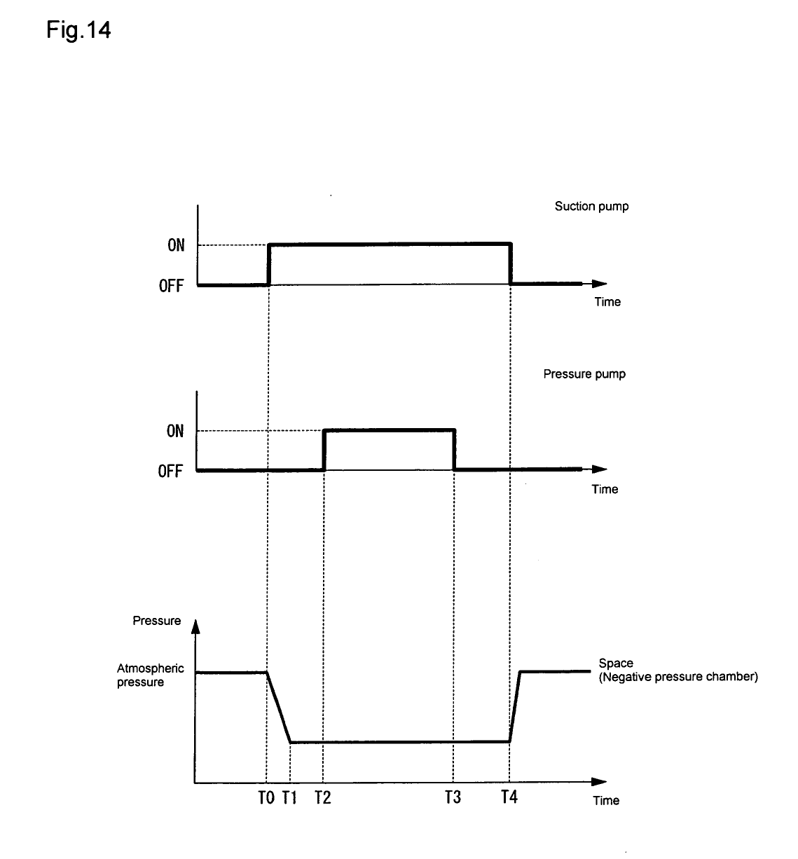

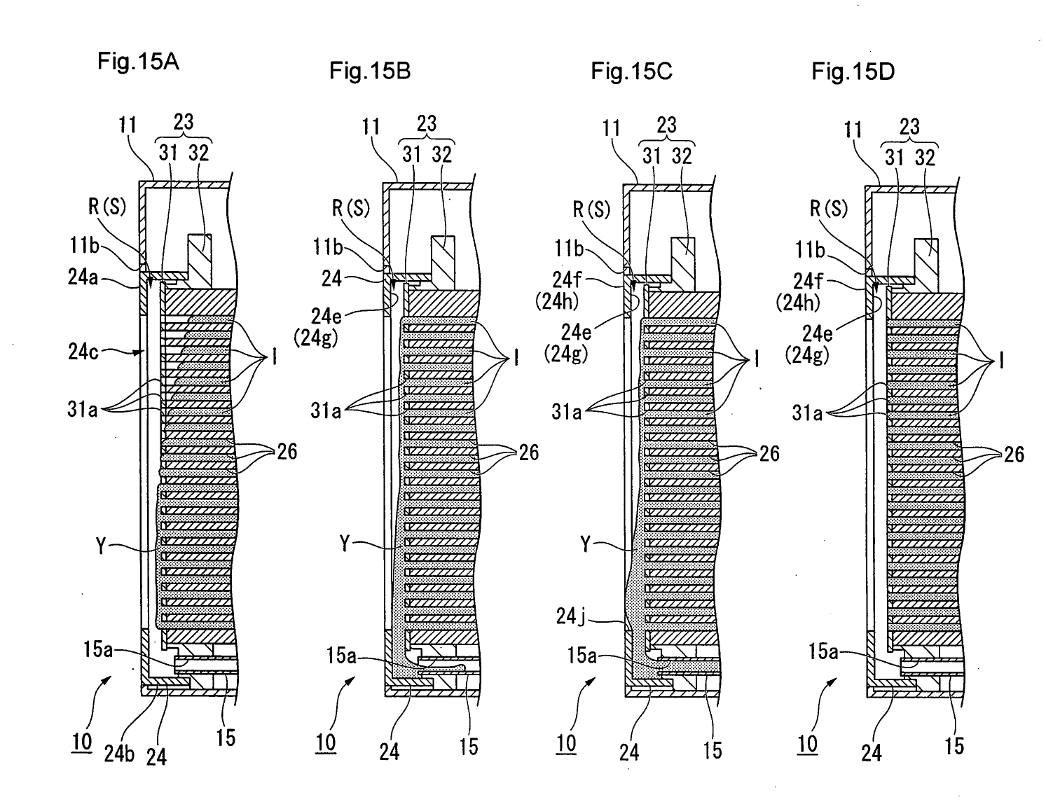

Here, FIG. 14 shows graphs of a relationship among operation timing of the suction pump 16, operation timing of the pressure pump 54, and the space S (negative pressure chamber R), and FIG. 15 are enlarged sectional views of a principal part of the head chip 20 illustrating operation of initial filling.

First, as illustrated in FIGS. 4 and 14, the suction pump 16 of the ink jet head 10 is operated and the suction pump 16 sucks air in the space S from the suction port 15a via the suction flow path 15 (at time T0 of FIG. 14). Here, outside air flows from the slit 24c in the space S. By sucking the air after the air passes through the space S and reaches the suction port 15a, the space S is depressurized. After a predetermined time passes, at T1, the space S becomes the negative pressure chamber R in which the pressure is negative enough compared with atmospheric pressure.

After the space S becomes the negative pressure chamber R, the ink supply portion 5 carries out pressure-filling of the ink I into the ink jet head 10 (at time T2 of FIG. 13). Here, the ink supply portion 5 is set as in the following. That is, as illustrated in FIG. 2, the changeover valve 53 communicates the supply tube 57a and the supply tube 57c with each other, and the open/close valve 55 is closed to interrupt the communication between the supply tube 57e and the supply tube 57f. With this state being kept, the pressure pump 54 is activated. The pressure pump 54 injects the ink I from the ink tank 51 via the supply tubes 57a, 57c, and 57d into the ink injection hole 11d of the ink jet head 10.

As illustrated in FIGS. 4 and 5, the ink I injected into the ink injection hole 11d flows in the storing chamber 17a via the ink intake hole 17b in the damper 17, and then, flows out to the circulation path 18a in the ink flow path substrate 18 via the ink outflow hole 17c. Then, the ink I which flows in the circulation path 18a flows in the respective long grooves 26 via the open hole 22c.

The ink I which flows in the respective long grooves 26 flows to the nozzle hole 31a side, and, after reaching the nozzle holes 31a, as illustrated in FIG. 15(a), flows out from the nozzle holes 31a as excess ink Y. At the beginning of the outflow of the excess ink Y, because the amount is small, the excess ink Y flows downward (downward in the direction of gravity) on the nozzle plate 31. The excess ink Y which reaches a lower portion of the negative pressure chamber R is sucked from the suction port 15a into the suction flow path 15. With this, the excess ink Y is discharged to the waste liquid tank E (see FIG. 15(b)).

Here, in the case in which the amount of the excess ink Y which flows out is large, as illustrated in FIG. 15(b), the excess ink Y flows down not only on the nozzle plate 31 but also on the inner surface 24e of the nozzle guard 24. Here, air continuously flows in the negative pressure chamber R via the slit 24c and thus, the excess ink Y is less liable to flow out of the slit 24c to the outside. Supposing, as illustrated in FIG. 15(c), the amount of the excess ink Y which flows on the inner surface 24e in proximity to the slit 24c becomes locally large and a part of the excess ink Y reaches the vicinity of the outer surface 24f against air which flows in via the slit 24c, the excess ink Y is repelled by the water-repellent film 24h formed on the outer surface 24f. The repelled ink I is guided by the hydrophilic film 24g formed on the inner surface 24e and returns to the negative pressure chamber R again.

Further, in the lower end portion 24j of the slit 24c, surface tension acts on the ink I at the contour of a circular lower end portion 24j (at the boundary between the outer surface 24f and the lower end portion 24j). In the lower end portion 24j, strong surface tension acts on the ink I and the balance of the surface tension is kept, and thus, the surface of the ink I is not broken and the ink I does not leak to the outside. Further, similarly to the case described above, the ink I is guided by the water-repellent film 24h formed on the outer surface 24f and the hydrophilic film 24g formed on the inner surface 24e to be returned to the negative pressure chamber R.

In this way, the excess ink Y which flows out of the nozzle holes 31a is continuously discharged to the waste liquid tank E.

As shown in FIG. 14, after a predetermined time passes, at T3, the pressure pump 54 is stopped to end the pressure-filling of the ink I. In association with the stop of the pressure pump 54, the excess ink Y no longer flows out of the nozzle holes 31a, and the excess ink Y which remains in the negative pressure chamber R is sucked, and the sucked excess ink Y is discharged to the waste liquid tank E via the suction port 15a.

Then, after a predetermined time passes, at T4, the suction pump 16 is stopped. After the filling of the ink I is completed, as illustrated in FIG. 15(d), the long grooves 26 are filled with the ink I. It is to be noted that the pressure in the space S recovers to be atmospheric pressure again (see FIG. 14).

After the filling of the ink I is completed, as illustrated in FIG. 1, the ink jet heads 10 which are arranged above the belt conveyor 2 are returned to the horizontal jet position in a way similar to the method of operating the rotating device described above. In this way, filling of the ink I into the ink jet heads 10 is completed.

As described above, according to this embodiment, there is provided the rotating device 60 which is attached to the ink jet head 10, for rotatably supporting the ink jet head 10 between the downward jet position for discharging the ink I under a state in which the direction of openings of the orifices 31b in the nozzle plate 31 is the direction of gravity and the horizontal jet position for discharging the ink I under a state in which the direction of openings of the orifices 31b is horizontal.

According to the structure, when the ink jet head 10 is rotated from the downward jet position to the horizontal jet position or from the horizontal jet position to the downward jet position, differently from a case in which the rotating operation is carried out only about the rotating shaft 69, as the rotating plate 63 is rotated with respect to the base unit 61, the slide mechanism 65 slides with respect to the rotating plate 63. In this case, when the rotation is to the downward jet position, the ink jet head 10 and the upper surface of the box D may be disposed so as to be opposed to each other, while, when the rotation is to the horizontal jet position, the ink jet head 10 may be retracted from over the box D. Because maintenance such as filling ink into the ink jet head 10 may be performed at the horizontal jet position, compared with a conventional structure in which the ink jet head 10 is moved to a service station or the like, the manufacturing cost of the apparatus may be reduced.

In addition, according to this embodiment, because the rotating shaft 69 is disposed at the end portion in the lower portion and on the front side of the rotating plate 63 at the horizontal jet position, the ink jet head 10 does not extend downward beyond the rotating shaft 69 too much when rotated to the downward jet position. Therefore, at the downward jet position, the clearance to the box D may be set as small as possible to improve the print precision, while, at the horizontal jet position, space below the ink jet head 10 may be effectively used.

In particular, by arranging above the belt conveyor 2 the ink jet head 10 which is at the downward jet position, ink is jetted downward in the direction of gravity from the orifices 31b of the ink jet head 10. With this, the ink jet head may be used as the ink jet head 10 of a downward jet type for carrying out printing on the upper surface of the box D. Further, in maintenance, by rotating the rotating unit 62 to the horizontal jet position, maintenance such as filling ink into the ink jet head 10 may be performed. In other words, printing (downward jet position) and maintenance (horizontal jet position) may be easily switched.

In this case, differently from a case in which the rotating operation is carried out only about the rotating shaft 69, the rotating unit 62 may be suppressed from protruding downward beyond the base unit 61 when the rotating unit 62 is rotated, and thus, even if the box D is disposed immediately below the ink jet head 10, the ink jet head 10 does not interfere with the box D when rotated. Therefore, in printing, the clearance to the box D may be set as small as possible to improve the print precision.

On the other hand, when the ink jet head 10 is arranged to a side of the box D, because it is not necessary to provide space below the ink jet head 10, the ink jet head 10 may be disposed as low as possible, which enables printing on a lower end portion of a side surface of the box D and printing on the box D the vertical dimension of which is small. More specifically, by arranging the ink jet head 10 at the horizontal jet position to a side of the belt conveyor 2, the ink I is jetted horizontally from the orifices 31b of the ink jet head 10. With this, the ink jet head may be used as the ink jet head 10 of a horizontal jet type for carrying out printing on a side surface of the box D.

Therefore, by attaching the ink jet head 10 to the rotating device 60, the print precision is kept, and still, both the function of downward jet and the function of horizontal jet may be achieved.

Further, by disposing the rocking gear 71 between the fixed gear 90 and the rack member 72, the rack member 72 may be disposed at an arbitrary position. This may improve the flexibility in the design, and still, may prevent the fixed gear 90 from becoming larger and may miniaturize the rotating device 60. In this case, for example, according to this embodiment, the rack member 72 may be disposed above the rotating shaft 69 at the downward jet position, and space below the rotating shaft 69 may be effectively used.

Still further, by disposing the end surface (lower surface in FIG. 13(b)) of the lower portion in the direction of gravity of the ink jet head 10 at the horizontal jet position so as to be flush with the end surface (lower surface in FIG. 13(a)) on the opening direction side of the ink jet head 10 at the downward jet position, the ink jet head 10 does not protrude downward in the direction of gravity from an outer shape of the base unit 61 both at the horizontal jet position and at the downward jet position. Therefore, it is easily possible that printing is carried out on a location in proximity to a lower end of the box D which is disposed on the belt conveyor 2 or the like.

Further, according to this embodiment, because the nozzle guard 24 is provided so as to cover the nozzle cap 32, the excess ink Y in initial filling of the ink I and in normal use flows out to the negative pressure chamber R which communicates with the outside only via the slit 24c, and air outside the negative pressure chamber R flows in the negative pressure chamber R via the slit 24c. This causes the excess ink Y to move through the negative pressure chamber R under a state in which the excess ink Y is less liable to leak to the outside via the slit 24c, and to be sucked from the suction port 15a into the suction flow path 15 to be discharged to the outside, and thus, the ink I which flows out of the orifices 31b may be reliably collected and the excess ink Y may be prevented from leaking from the ink jet head 10.

With this, in filling the ink I, only by rotating the ink jet head 10 to the horizontal jet position, contamination of the vicinity of the ink jet head 10 (for example, the box D or the belt conveyor 2) due to leakage of the excess ink Y may be prevented, and still, the ink I may be more reliably filled into the nozzle holes 31a.

Therefore, because it is not necessary to provide a cap and an ink absorber as in a conventional case, the ability to collect the excess ink Y may be improved with a simple structure, and space may be saved. More specifically, because the space factor in front of the orifices 31b of the ink jet head 10 may be improved, the clearance between the ink jet head 10 and the box D may be reduced. Further, because the space factor below the ink jet head 10 may also be improved, printing may be carried out on the lower end portion of the box D or on the box D the vertical dimension of which is small. As a result, the print precision of the ink jet head 10 may be improved.

Further, because the ink I may be continuously discharged through the suction flow path 15, the ability to collect the excess ink Y is extremely strong and, even if a large amount of the excess ink Y flows out, contamination with the excess ink Y may be prevented and jetting of the liquid after the ink I is filled may be stabilized. Further, initial filling of the ink jet recording apparatus 1 may be achieved with a simple structure.

It is to be noted that the operation procedure or the shapes and combinations of the structural members described in the above-mentioned embodiment are only exemplary, and various modifications based on design requirements and the like, which fall within the gist of the present invention, are possible.

For example, in the above-mentioned embodiment, a structure in which the rotating unit 62 is rotated by the motor unit 93 is described, but the motor unit 93 may not be provided and the rotating unit 62 may be manually rotated.

Further, in the above-mentioned embodiment, a case in which one ink jet head 10 is attached to one rotating device 60 is described, but the present invention is not limited thereto. A structure in which a plurality of ink jet heads 10 are attached to one rotating device 60 is also possible. In this case, for example, it is possible that the plurality of ink jet heads 10 are coupled to one another along a width direction thereof (thickness direction of the rotating plate 63) or are coupled to one another along a height direction thereof (direction of the long side of the rotating plate 63).

Further, the fixed gear 90 and the rack member 72 may be directly engaged with each other without the rocking gear 71 interposed therebetween.

Further, in this embodiment, the ink I or the cleaning liquid W is filled using both the pressure pump 54 and the suction pump 16, but the present invention is not limited thereto. For example, the ink I or the cleaning liquid W may be filled into the ink jet head 10 only by operation of the suction pump 16 (so-called suction filling).

Further, in this embodiment, as an actuator for discharging the ink I, the ceramic piezoelectric plate 21 having electrodes provided thereon is included, but the present invention is not limited thereto. For example, a mechanism in which an electrothermal conversion element is used to generate air bubbles in the chamber into which the ink I is filled and the ink I is discharged by the pressure of the air bubbles may be provided.

Further, in this embodiment, the open hole 22c is formed in the direction of the long grooves 26 which are provided side by side, and the ink I is filled into the long grooves 26 from the open hole 22c, but the present invention is not limited thereto. For example, the open hole 22c may be provided so as not to communicate with all the long grooves 26, slit-shaped grooves may be provided in the ink chamber plate 22, and the pitch of providing the slits may be half the pitch of providing the long grooves 26. More specifically, the slits may correspond to every other long groove 26 and the ink I may be filled into only long grooves 26 which correspond to the slits, respectively. By adopting this form, even if the used ink I is conductive, the electrodes do not establish a short circuit via the ink I, and various kinds of the ink I may be adopted to carry out printing.

### DESCRIPTION OF SYMBOLS

1 . . . ink jet recording apparatus (liquid jet recording apparatus)

2 . . . belt conveyor (transfer means)

10 . . . ink jet head (liquid jet head)

15 . . . suction flow path

15a . . . suction port

16 . . . suction pump (sucking portion)

23 . . . nozzle body

24 . . . nozzle guard (jetting body guard)

24a . . . top plate portion

24b . . . airtight portion

24c . . . slit

31a . . . nozzle hole

31b . . . orifice (nozzle)

31c . . . nozzle column (jetting hole column)

60 . . . rotating device

61 . . . base unit

62 . . . rotating unit

63 . . . rotating plate (rotating member)

75 . . . head attaching plate (slide member)

69 . . . rotating shaft

72 . . . rack member

92 . . . torque limiter

93 . . . motor unit (drive means)

98 . . . plunger

D . . . box (recording medium)

I . . . ink (liquid)

R . . . negative pressure chamber

S . . . space (inside space)

1. A rotating device for a liquid jet head, to which a liquid jet head for discharging liquid toward a recording medium is attached, the rotating device being for rotating the liquid jet head between a first position at which the liquid jet head is disposed under a state in which a direction of openings of nozzles thereof is a direction of gravity and a second position at which the liquid jet head is disposed under a state in which the direction of openings of the nozzles thereof is horizontal,
the rotating device comprising:
a rotating unit to which the liquid jet head is attached; and
a base unit for rotatably supporting the rotating unit,
the rotating unit comprising:
a rotating member rotatably supported by the base unit via a rotating shaft; and
a slide member supported so as to be slidable in a direction of a radius of the rotation shaft with respect to the rotating member and to which the liquid jet head is attached,
the slide member being formed so as to slide with respect to the rotating member in synchronization with rotating operation of the rotating member,
wherein the rotating shaft is disposed at an end portion in a first direction and in a second direction of the rotating unit at the second position,
provided that the direction of openings of the nozzles of the liquid jet head at the first position is the first direction and the direction of openings of the nozzles of the liquid jet head at the second position is the second direction.

2. A rotating device for a liquid jet head according to claim 1, wherein:
the rotating unit comprises a rack member coupled to the slide member; and
the base unit comprises drive means for rotating the rotating shaft of the rotating member and a fixed gear fixed to the base unit under a state of being directly or indirectly engaged with the rack member.

3. A rotating device for a liquid jet head according to claim 2, wherein a rocking gear which is rotatably supported by the rotating member is provided between the fixed gear and the rack member under a state of being engaged with the fixed gear and the rack member.

4.-12. (canceled)
